(19) United States
(12) Patent Application Publication
(10) Pub. No.: US 2010/0255310 A1
(43) Pub. Date: Oct. 7, 2010

(54) TOTALLY POROUS PARTICLES AND METHODS OF MAKING AND USING SAME

(76) Inventors: Wu Chen, Newark, DE (US); Ta-Chen Wei, Newark, DE (US)

Correspondence Address: Agilent Technologies, Inc. in care of:;CPA Global, P. O. Box 52050, Minneapolis, MN, 55402, US

(21) Appl. No.: 12/418,915

(22) Filed: Apr. 6, 2009

(51) Int. Cl. B32B 5/16; B05D 7/00

(52) U.S. Cl. 428/403; 427/214; 427/212

(57) ABSTRACT

Disclosed are totally porous particles, methods of making the particles, and uses thereof.

### FIELD OF INVENTION

The present invention relates to totally porous particles, including layered and multilayered totally porous particles, methods of making the particles, and uses thereof.

### BACKGROUND

Totally porous particles are particles that are porous throughout. Such particles can be useful in a variety of applications, including for example, catalysis and chromatography. For most applications, micron scale totally porous particles are used, typically having diameters less than 500 μm. Totally porous particles generally have strong mechanical strength, high surface area, and reactive surface groups which allow for further chemical modification to the surface. Totally porous silica particles, for example, have been widely used as a solid supports for catalysis, solid phase synthesis, solid phase extraction, and chromatographic packing materials such as size exclusion chromatography and reversed phase chromatography.

Totally porous particles are typically synthesized by the sol-gel method, spray dry method, emulsion polymerization, or other methods. However, such methods are currently deficient in providing porous particles having optimal properties, including size and size distribution, and performance. Additionally, current methods for preparing totally porous particles are not suitable for forming layered or multilayered porous particles wherein at least two or more layers can have different pore sizes and/or pore structures.

Accordingly, there is a need for improved methods for making totally porous particles, and in particular methods which can provide improved particle and pore size distribution, as well as totally porous particles comprising a layered or multi layered structure. These needs and other needs are satisfied by the present invention.

### SUMMARY OF INVENTION

In accordance with the purpose(s) of the invention, as embodied and broadly described herein, the invention, in one aspect, relates to improved methods for making totally porous particles, particles produced by the methods, and uses of the particles.

In one aspect of the present invention, the porous particles are made by attaching an organic surface modifier to a porous metal oxide core particle to provide a surface modified metal oxide core particle. A coating can then be formed on the surface modified metal oxide core particle, wherein the coating comprises a continuous polymeric phase bonded to the organic surface modifier and a particulate phase dispersed within the continuous polymeric phase. The continuous polymeric phase can then be removed from the coating to provide a porous particle.

Also disclosed are a plurality of totally porous particles, wherein at least one of the totally porous particles is aggregated with a smaller totally porous particle.

Also disclosed are separation devices having a stationary phase comprising a plurality of totally porous particles, wherein at least one of the totally porous particles is aggregated with a smaller totally porous particle having a substantially homogenous pore size, which does not comprise the porous core particle.

The advantages of the invention will be set forth in part in the description which follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

FIG. 1 is a diagram of the cross-section of a multilayered totally porous particle, in accordance with the various aspects of the present invention.

FIG. 2 is a micrograph of multilayered totally porous particles, produced in accordance with the various aspects of the present invention.

FIG. 3 is a plot of particle size for the particles of Example 3, in accordance with the various aspects of the present invention.

### DETAILED DESCRIPTION OF THE INVENTION

Before the present compounds, compositions, particles, devices, articles, methods, or uses are disclosed and described, it is to be understood that the aspects described below are not limited to specific compounds, compositions, particles, devices, articles, methods, or uses as such may, of course, vary. It is also to be understood that the terminology used herein is for the purpose of describing particular aspects only and is not intended to be limiting.

In this specification and in the claims that follow, reference will be made to a number of terms that shall be defined to have the following meanings:

Throughout this specification, unless the context requires otherwise, the word “comprise,” or variations such as “comprises” or “comprising,” will be understood to imply the inclusion of a stated component or step or group of components or steps but not the exclusion of any other component or step or group of components or steps.

It must be noted that, as used in the specification and the appended claims, the singular forms “a,” “an” and “the” include plural referents unless the context clearly dictates otherwise. Thus, for example, reference to “a particle” includes mixtures of two or more such particles.

“Optional” or “optionally” means that the subsequently described event or circumstance can or cannot occur, and that the description includes instances where the event or circumstance occurs and instances where it does not.

Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, a “wt. %” or “weight percent” or “percent by weight” of a component in a composition or mixture, unless specifically stated to the contrary, is based on the total weight of the composition of mixture in which the component is included.

As used herein, “median particle size” refers to the median or the 50% quantile of total particle size distribution.

As used herein, “coacervation” refers to a process by which a raw particle can be formed or by which a porous layer can be formed around a core particle. In one aspect, a particulate phase is dispersed within a continuous polymeric phase. The “coacervate,” in one aspect, is the polymer of the continuous polymer phase. After formation of the coacervate, the continuous polymeric phase can be removed to provide a porous particle comprising the remaining particulate phase. The term “coacervation” refers to a process defined herein, and is not restricted to any particular composition or chemical reaction. Likewise, the terms “coacervation layer,” and “coacervate” refer to compositions that are not restrictive to any particular method for making the coacervation layer or coacervate.

A “core particle,” as used herein, refers to a porous metal oxide particle or a raw particle, as defined herein.

Disclosed are compounds, compositions, and particles that can be used for, can be used in conjunction with, can be used in preparation for, or are products of the disclosed methods and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a number of different polymers and core particles are disclosed and discussed, each and every combination and permutation of the polymer and core particles are specifically contemplated unless specifically indicated to the contrary. Thus, if a class of polymers A, B, and C are disclosed as well as a class of core particles D, E, and F and an example of a combination particle coated with the polymer, A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B; and C, D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to, steps in methods of making and using the disclosed particles. Thus, if there are a variety of additional steps that can be performed it is understood that each of these additional steps can be performed with any specific embodiment or combination of embodiments of the disclosed methods, and that each combination is specifically contemplated and should be considered disclosed.

The particles of the invention are totally porous particles (e.g., layered or multilayered porous particles) that comprise a porous metal oxide core surrounded by one or more porous layers. The core and each layer can have the same or different pore size and/or pore structure, depending on the desired application of the particle. The particles are made by a coacervation method, wherein a one or more layers of having the same or different pore structures are applied to the core particle to form a totally porous particle. The particles of the invention are useful in a variety of applications, including catalysis, solid phase extraction, and chromatography, particularly size exclusion chromatography.

The core particle can have any desired shape, which will generally depend on the targeted application. For chromatographic applications, suitable shapes include without limitation spheres, rings, polyhedra, saddles, platelets, fibers, hollow tubes, rods and cylinders, and mixtures of any two or more such shapes. In one aspect, the core is substantially spherical. Spherical cores can be easily packed and are thus desirable for certain applications, such as chromatography.

The composition of the core particle is not critical, provided that the core be compatible with the coacervation methods described herein. Suitable core materials include without limitation glasses, sands, metals, metalloids, ceramics, and combinations thereof. It should be understood that the shape, composition, and size of the core particles can be distributional properties that vary. To that end, it is not required that all the core particles in a given population comprise a uniform size, composition, or shape. It is therefore contemplated that according to aspects of the invention, all or substantially all core particles have the same or similar size, shape, and composition. Alternatively, it is also contemplated that according to other aspects of the invention, the shape, composition, and size of core particles in a given population can vary.

In one aspect, the core particle comprises a metal oxide, such as a refractory metal oxide. In a further aspect, the core particle is a porous metal oxide particle. Exemplary metal oxides include without limitation silica, alumina, titania, zirconia, ferric oxide, antimony oxide, zinc oxide, and tin oxide. In another aspect, the core particle can comprise silica, alumina, titania, zirconia, or a combination thereof. In a further aspect, the core particle comprises silica. In one aspect, the metal oxide particle with surface hydroxyl groups can be modified with a disclosed surface modifier.

When the core particle is a metal oxide particle, it was discovered that, prior to forming a coacervate layer on the surface of a core particle, the core particle can be advantageously modified with a material that enhances the formation of the coacervate coating. By enhancing the formation of the coacervate coating, a number of advantages are realized, including the ability to make particles having smaller particle sizes (e.g., from about 0.5 to about 10 μm) and smaller size distributions than conventional methods known in the art, as well as allowing for the control of pore sizes among the one or more layers surrounding the core. In application, the particles made by the disclosed exhibit improved performance in separation devices.

In another aspect, the core particle is a raw particle. Raw particles are particles comprising small metal oxide particles dispersed within a polymeric particulate phase. Assuming the raw particle comprises an appropriate polymeric phase, the raw particle need not be further modified with an organic surface modifier, as defined herein, since the raw particle is already suitable for binding to a coacervation layer. The small metal oxide particles within the raw particle can comprise any suitable metal oxide, for example, silica, alumina, titania, zirconia, ferric oxide, antimony oxide, zinc oxide, and tin oxide. The metal oxide particles of the raw particle are typically nanometer sized, but the size can vary as needed. The size of the particles in the particulate phase of the raw particle can affect the pore size of at a all of or a portion of the pores in the final totally porous particle. Generally, the raw particles are prepared by coacervation. Typically, a sol of metal oxide particles is dispersed within a continuous polymer phase to form the raw particle. Examples of suitable continuous polymeric phases for the raw particle include poly(urea-formaldehyde) and/or poly(melamine).

The coacervation process used to prepare the raw particles is substantially the same as the coacervation process used to form coacervate layers around the core particle, which is described below. The continuous polymeric phase of the raw particle, in various aspects, can bond to the continuous polymer phase of a coacervation layer formed around the raw particle. The bonding can be covalent or noncovalent. Once the continuous polymeric phases are removed (including the continuous polymeric phase of the raw particle), a totally porous particle is formed. The core of the totally porous particle comprises the small metal oxide particles from the raw particle, and the one or more layers surrounding the core comprise the particulate phase(s) from the coacervation layer(s).

The core particles can have any desired size, depending on the desired size of the porous particle. Generally, the core particle is larger than the colloidal particles used to form the porous layer. In one aspect, the core particle has a size ranging from about 10% to about 99% of the total particle size.

In one aspect, the core particles have a median particle size from about 0.1 μm to about 100 μm, including without limitation core particles having a median particle size from about 0.5, 2, 4, 6, 8, 10, 12, 14, 16, 18, 20, 30, 40, 50, 60, 70, 80, and 90 μm. It will be apparent the disclosed methods are useful for smaller particles, e.g. totally porous particles having median particle sizes less than about 10 μm, or less than about 5 μm. Such particles can be prepared from corresponding core particles having median particle sizes of from about 0.1 to about 10 μm, or from about 0.1 to about 5 μm, or from about 0.1 to about 3 μm. In specific aspects, a core particles (e.g. silica) have a median particle size of from about 1 to about 3 μm, including without limitation 1, 1.2, 1.5, 1.8, 1.9, 2, 2.2, 2.5, 2.7, and 3 μm.

Depending on the conditions used during coacervation, the median size of the core particle can change throughout the process. For example, after sintering, the core of the totally porous particle can be smaller than the core used as the starting material. To that end, in one aspect, those median sizes disclosed above refer to core sizes prior to processing. In another aspect, the size of the core remains substantially similar after processing, and those sizes disclosed above also refer to the size of the core in the final porous particle. In a further aspect, those sizes disclosed above refer to the size of the core in the final particle, regardless of the size of the starting material core. Particle size can be determined using methods known in the art, for example through the use of a Coulter Counter, which can also count particles and thus provide particle size distributions.

The particle size distribution of the core particles can vary depending on the composition of the core particle and the method in which the core particle was made and/or processed. In one aspect, the core particles have a particle size distribution of less than about 20% of the median particle size, including for example, less than about 15%, less than about 10%, or less than about 5% of the median particle size. In a further aspect, the core particles have a particle size distribution of from about 0.5% to about 10% of the median particle size, including without limitation particle size distributions of from about 0.5% to about 8%, 0.5% to about 6%, and from about 0.5% to about 5% of the median particle size.

When the core particle is a metal oxide particle, i.e. not a raw particle or a particle already comprising a continuous polymeric phase, it can be useful to first attach an organic surface modifier to the core particle, to aid in the formation of the coacervate layer around the core particle, as briefly discussed above. If desired, although typically not necessary, an organic surface modifier can also be added to a raw particle. When the coacervation layer comprises a continuous polymeric phase having a dispersed particulate phase therein, the organic surface modifier can, in various aspects, enhance the binding of the continuous polymer phase to the core particle. In certain aspects, the organic surface modifier can bond to the coacervate layer and/or the continuous polymer phase. In further aspects, the organic surface modifier can covalently bond to the continuous polymer phase. For example, the organic surface modifier can be a residue from which a polymerization can begin and/or a residue to which an oligomer or polymer can covalently bond. Thus, in various aspects, the organic surface modifier functions to aid in the formation of the coacervation layer around the core particle by attracting the continuous polymer phase or precursor(s) thereof to the surface of the core particle. By doing so, the particulate phase of the coacervation layer, which is or becomes dispersed in the continuous polymer phase, is also thereby attracted to the surface, allowing a well-defined porous layer to form around the core, once the continuous polymer phase is removed.

The composition of the organic surface modifier is not critical, provided that it provides the desired result. Generally, however, the organic surface modifier is chemically similar (or can bond or react) to the polymer or precursor(s) thereof used to form the coacervation layer. In one aspect, the organic surface modifier has the same or a similar functional group as the polymer in the coacervation layer.

In certain aspects, when the continuous polymer phase comprises poly(urea-formaldehyde) and/or poly(melamine), the organic surface modifier comprises a functional group that can react with a precursor urea, formaldehyde, or melamine monomer; or oligomer or polymer thereof. In the specific case of poly(urea-formaldehyde) or poly(melamine), suitable functional groups include electrophilic or nucleophilic groups that can react with urea, formaldehyde, melamine, or an oligomer or polymer thereof. Exemplary functional groups that can react with formaldehyde include without limitation alcohols, thiols, amines, amides, among others. A specific example is a ureido residue. Suitable functional groups that can react with urea and/or melamine include ketones, aldehydes, isocyanates, acryl groups, epoxy groups, glycidoxy groups, among others.

In one aspect, the organic surface modifier is covalently bonded to the surface of the core particle. In a further aspect, the organic surface modifier is covalently bonded to one or more surface oxygen atoms (i.e., formerly hydroxyl groups, prior to attaching the organic surface modifier) of the core metal oxide particle. In a still further aspect, the organic surface modifier is covalently bonded to the surface of the core particle through one or more M-O— bonds, wherein M is Si, Al, Ti, Zr, Fe, Sb, Zn, or Sn.

In specific aspects, the organic surface modifier can comprise an organosilane residue that is bonded to the surface of a metal oxide particle (e.g. a silica particle). A variety of organosilane residues can be used, provided they are capable of bonding to the continuous polymer phase of the coacervation layer. In one aspect, the organosilane comprises one or more of those functional groups discussed above. In one aspect, the organic surface modifier comprises a ureido residue, an aldehyde residue, or an amine residue. In a further aspect, the organosilane is (aminopropyl)triethoxysilane, (3-trimethoxysilylpropyl)diethylenetriamine, (3-glycidoxypropyl)trimethoxysilane, (isocyanatopropyl)triethoxysilane, (isocyanatopropyl)triethoxysilane, (isocyanatopropyl)triethoxysilane, or (isocyanatopropyl)triethoxysilane. In a further aspect, the organosilane is not (aminopropyl)triethoxysilane, (3-trimethoxysilylpropyl)diethylenetriamine, (3-glycidoxypropyl)trimethoxysilane, (isocyanatopropyl)triethoxysilane, (isocyanatopropyl)triethoxysilane, (isocyanatopropyl)triethoxysilane, or (isocyanatopropyl)triethoxysilane.

In further aspects, when the continuous polymer phase comprises poly(urea-formaldehyde), the organosilane used to form the organic surface modifier can comprise one or more of (aminopropyl)triethoxysilane, (3-trimethoxysilylpropyl)diethylenetriamine, (3-glycidoxypropyl)trimethoxysilane, or ureidopropyltrimethoxysilane.

In a further aspect, the organic surface modifier is itself an oligomer or polymer, which can be the same or different than the polymer used in the coacervation layer. The oligomer or polymer can be physisorbed and/or bonded to the surface of the core particle. Thus, the oligomer or polymer can be covalently or non-covalently (e.g., electrostatically, hydrophilically/hydrophobically, hydrogen bonded, coordinated, etc.) bonded to the surface of the core particle, or can be merely physisorbed where no chemical bond exists. An example of a polymer that can be covalently bonded to a surface of a core particle is poly(1-vinylpyrrolidone-co-2-dimethylaminoethyl methacrylate).

In one aspect, the organic surface modifier is noncovalently bonded (e.g., hydrogen bonded, coordinated, etc.) and/or physisorbed to the surface of the core particle. For example, if the continuous polymer phase of the coacervation layer comprises poly(urea-formaldehyde), the organic surface modifier can be poly(urea-formaldehyde). In this aspect, it can be preferable that the poly(urea-formaldehyde) used as the organic surface modifier is oligomeric, or at least smaller than the polymer used in the coacervation layer. In this exemplary aspect, the organic surface modifier becomes a part of the continuous polymer phase. In other aspects, polymers such as polyethylenimine, polyacrylamide, or poly(melamine) can be noncovalently bonded or physisorbed to the surface of the core particle.

In one aspect, when the core particle is a metal oxide particle, the method for making the totally porous particles first comprises providing a solid metal oxide core particle having an organic surface modifier attached to a surface thereof. This step can be accomplished, in various aspects, by attaching an organic surface modifier to the metal oxide core particle to provide a surface modified metal oxide core particle, as discussed above. The surface modifier can be attached to the core particle through various means. When the modifier is covalently bonded to the surface of the core particle, a reactive residue, oligomer, or polymer can be reacted with one or more surface hydroxyl groups, or another functional group on the surface, under conditions effective to form a covalent bond. Various methods for modifying the surface of metal oxide particles are known in the art.

When the modifier is a polymer, for example, the core particle can be placed in a solution of one or more monomers, and the one or more monomers can be polymerized, thereby adhering the polymer or oligomer to the surface of the core, through a chemical bond, physisorption, or both. In a specific aspect, a core particle can be placed in a solution of urea and formaldehyde, and the pH of the solution can be adjusted to thereby produce a desired oligomer or polymer of urea and formaldehyde, which can chemically react with a functional group attached to the surface and/or physisorb to the surface of the core particle during or after polymerization. In various aspects, the solution can be adjusted to a pH of from about 1.5 to about 5.5, for example, about 1.5, 1.7, 1.8, 2, 2.2, 2.4, 2.6, 2.8, 3.1, 3.3, 3.5, 3.7, 3.9, 4.1, 4.3, 4.5, 4.7, 4.9, 5.1, 5.3, or 5.5. In other aspects, the solution can be adjusted to any pH suitable for achieving the desired results. Prior to dropping the pH to from about 1.5 to about 5.5, the pH of the solution should typically be basic, e.g. from about pH 10-11, to prevent undesired polymerization. Following the formation of the oligo- or poly(urea-formaldehyde), the pH of the solution can be raised, for example to about pH 9, to aid in breaking up excess poly(urea-formaldehyde) that is formed. It is understood that the above disclosed process for preparing a core particle modified with an oligo- or poly(urea-formaldehyde) is suitable for instances wherein the oligo- or poly(urea-formaldehyde) is chemically bonded and/or physisorbed to the core particle.

The raw particle can be prepared by coacervation in an analogous manner. Thus, a metal oxide sol (the particulate phase of the raw particle) can be placed in a solution of one or more monomers, and the one or more monomers can be polymerized, thereby adhering the polymer or oligomer to the metal oxide sol, through a chemical bond, physisorption, or both. In a specific aspect, metal oxide sol can be placed in a solution of urea and formaldehyde, and the pH of the solution can be adjusted to from about 1.5 to about 5.5, to thereby produce a desired oligomer or polymer of urea and formaldehyde, which can chemically react with a functional group attached to the surfaces and/or physisorbed to the surfaces of the metal oxide sol particles. Prior to dropping the pH to from about 1.5 to about 5.5, the pH of the solution should typically be basic, e.g. from about pH 10-11, to prevent undesired polymerization. Following the formation of the oligo- or poly(urea-formaldehyde), the pH of the solution can be raised, for example to about pH 9, to aid in breaking up excess poly(urea-formaldehyde) that is formed. It is understood that the above disclosed process for preparing a raw particle is suitable for instances wherein the oligo- or poly(urea-formaldehyde) is chemically bonded and/or physisorbed to the metal oxide sol.

Once the surface modified core particle is provided, or a raw particle is provided, the coacervation coating can be formed or applied to the core particle. Generally, the coacervation coating comprises a continuous polymeric phase bonded to either the organic surface modifier of the metal oxide core particle or the continuous polymeric phase of the raw particle, and a particulate phase dispersed within the continuous polymeric phase of the coacervation coating. As discussed above, the coacervation coating or a portion thereof adheres or bonds to the organic surface modifier or the polymeric phase of the raw particle to enhance the formation of the porous layer around the core particle.

The polymeric phase of the coacervation layer can comprise any suitable polymer which can comprise a dispersed particulate phase and which can covalently, noncovalently, or physically bond to the surface modifed particle or raw particle. In one aspect, a suitable polymer is cross-linkable polymer. It will be apparent that the cross-linking ability of the polymer can aid in the dispersion of the particulate phase within the polymer. In one aspect, the continuous polymer phase comprises a poly(urea-formaldehyde), poly(melamine), or a combination, or copolymer thereof.

The particulate phase of the coacervation layer(s) generally comprise metal oxide particles, which are typically smaller in size than the core particle size. The composition of the particulate phase can comprise any of those metal oxides described above. In one aspect, the particulate phase comprises a refractory metal oxide particle. Exemplary metal oxides include without limitation silica, alumina, titania, zirconia, ferric oxide, antimony oxide, zinc oxide, and tin oxide. In another aspect, the particulate phase can comprise silica, alumina, titania, zirconia, or a combination thereof. In a further aspect, the particulate phase comprises silica.

The particles of the particulate phase of the coacervation layer can have any desired size. Preferably, the particulate phase particles are smaller in size than the core particle, such as, for example, about 10%, 25%, 50%, or 75% smaller than the core particle, or smaller. In one aspect, the particles of the particulate phase are nano-scale sized particles. For example, the particles can have a size or average diameter from about 1 nm to about 1000 nm, including without limitation particles having an average diameter from about 1 nm to about 100 nm, from about 1 nm to about 50 nm, from about 1 nm to about 30 nm, from about 1 nm to about 15 nm, or from about 1 nm to about 10 nm. The particles of the particulate phase can have any suitable particle size distribution, including for example 50%, 30%, 20%, 10%, 5%, or less of the median particle size. In one aspect, the particulate phase comprises silica, and is formed from silica sol, or colloidal silica.

The coacervate composition can be provided using various methods. In one aspect, the coacervate composition is formed and coated onto the modified core particle in one pot. In a further aspect, the coacervate layer can be formed by placing the core particles in a solution or dispersion of one or more monomers used to form the continuous polymer phase and particles used to form the particulate phase. The monomers can be polymerized into oligomers or polymers, which will comprise dispersed therein the particulate phase, and which can bind to the core particle. In a specific aspect, the core particle can be placed into a solution or dispersion of particles, such as silica sol. The solution or dispersion can then be agitated, to thereby reduce agglomeration of the particles. Then, the monomer(s) can be added into the solution or dispersion, followed by the polymerization of the monomers.

In a further specific aspect, when the continuous polymer of the coacervation layer phase comprises poly(urea-formaldehyde), the modified core particle or raw particle can be added to a solution or dispersion of silica sol, followed by optional agitation, and then urea and formaldehyde can be added to the solution, followed by the polymerization of the urea and formaldehyde under a pH effective to form the desired continuous polymer phase (e.g., lower than 2, and preferably 1.5). The raw particle, as discussed above, can be prepared in an analogous fashion, by adding urea and formaldehyde to silica sol.

Once the coacervate coating is formed, additional layers can be added by repeating the process steps discussed above. In forming subsequent layers, an additional coacervation composition can be added to the coated particle, such that a subsequent polymeric phase and dispersed particulate phase form around the coated particle. Thus, in one aspect, prior to removing the first continuous polymeric phase and/or the continuous polymer phase of the raw particle, at least one subsequent coating layer is formed, wherein the at least one subsequent coating layer comprises a subsequent continuous polymeric phase bonded to a previous continuous polymeric phase of a previous coating layer and a subsequent particulate phase dispersed within the subsequent continuous polymeric phase. Upon removal of the first continuous polymeric phase, the continuous polymeric phase of each subsequent coating layer is also removed to provide the totally porous particle. The first coating, as discussed above, first bonds to the organic surface modifier or polymeric phase of the raw particle, whereas subsequent coatings, generally bond to the preceding coating. For example, the polymeric phase of the first coating bonds to the organic surface modifier or polymeric phase of the raw particle, as discussed above, while the polymeric phase of the second coating bonds to the polymeric phase of the first coating, through the same or different means as the bonding of the first polymeric phase with the organic surface modifier or raw particle. The composition and bonding of subsequent layers with polymeric phases of adjacent layers is characterized by any of those means referenced above in the discussion of the coacervate coatings.

The one or more polymeric phases (including a polymeric phase of a raw particle, if present) is removed by heating the particles at a temperature sufficient to burn off the polymeric phase, for example from about 500° C. to about 800° C. for a sufficient time (e.g., about 2 to 3 hours). If desired, the particles can be sintered to solidify and strengthen the particles and/or reduce undesired micropores in the porous particle (i.e. the particulate phase). Sintering can be accomplished, for example, at a temperature of from about 900° C. to about 1500° C., including for example, 1000° C. If desired, the surface of the particles can be rehydroxylated, using methods discussed above. Additionally, the particles can be size-classified by liquid elutriation.

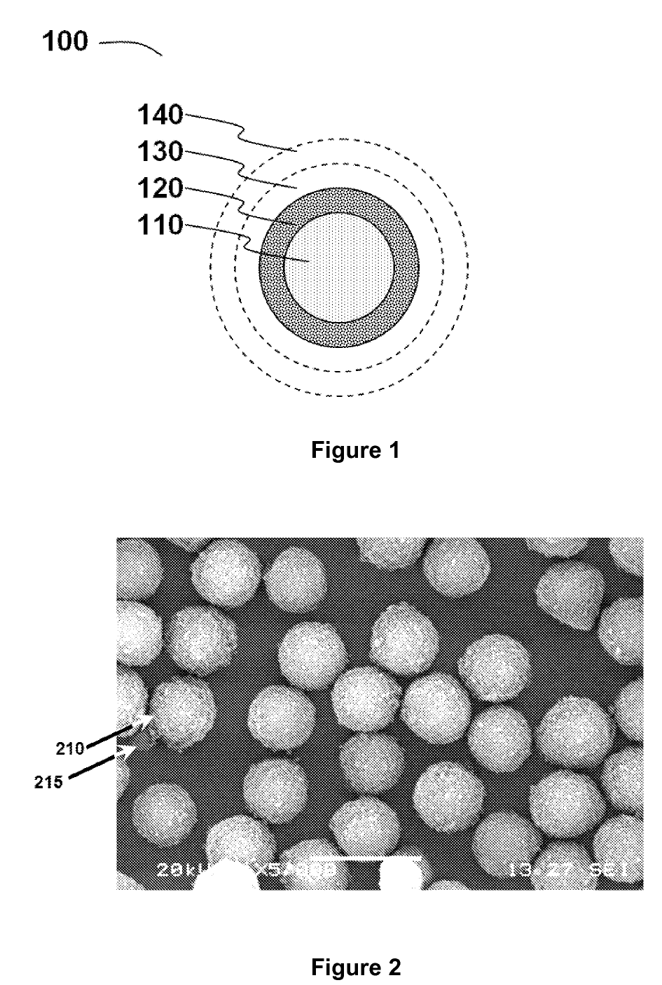

The disclosed totally porous particles can be made by the disclosed methods, or other methods. The porous particles can have any shape or composition discussed above. For example, with reference to FIG. 1, a spherical totally porous particle 100 generally comprises a core porous particle 110, which is surrounded by a first porous layer 120 comprising a pore size and structure that is the same or different as the core particle and optionally one or more additional porous layers (e.g. 130, 140), each having an independent pore sizes and/or structures that can be the same or different. The porous layers surrounding the porous core particle comprise the metal oxide particles from the particulate phase used to make the particles using the coacervation method. The size of the particles in the particulate phase used during the coacervation method, as discussed above, generally dictate the size of the pores in the layers surrounding the core particle, and thus can be selected or modulated as desired. Additionally, the size, size distribution, and composition of the metal oxide particles used in forming the one or more layers around the core particle can affect the pore structure of the final particle. Thus, by appropriately selecting a metal oxide particle composition, totally porous particles can be provided having multiple layers defined at least in part by varying pore sizes and/or pore structures. For example, one layer can comprise hexagonal packing, whereas another layer can comprise cylindrical packing. A wide variety of pore structures can be produced using the disclosed methods.

In one aspect, the composition of a sol, such as the metal oxide particles, can vary within a given layer and/or between any one or more layers. Moreover, the composition of a sol or any given layer can comprise one or more metal oxide materials. For example, a given layer can comprise one or a combination of metal oxide particles having the same or varying chemical compositions, structures, etc. If multiple layers are present, the composition of any one or more layers can also vary, by for example, chemical composition, structure, etc., from any other layer.

In one aspect, once the final totally porous particle is provided, the porous core has a size ranging from about 10% to about 99% of the total particle size, including without limitation 30%, 40%, 50%, 60%, 70%, 80%, or 90% of the total particle size. The porous layer(s) surrounding the core particle can have any desired porosity. In one aspect, the particles have one or more layers having substantially ordered pores with independent structures and/or median pore sizes from about 15 to about 1000 Å, including for example about 20, 50, 100, 200, 500, 700, 800, or 900 Å median pore sizes. The totally porous particles generally have a surface area of from about 5 to about 1000 m²/g. For example, the totally porous particles can have a surface area of from about 5 to about 200 m²/g.

The totally porous particles can have any desired size, depending on the size of the core particle and the thickness of the one or more layers surrounding the core particle. In one aspect, the particles have a median particle diameter from about 0.1 to about 100 μm, including for example, particles having a median diameter from about 0.1 to about 50 μm, 0.1 to about 30 μm, 0.1 to about 20 μm, 0.1 to about 10 μm, or 0.5 to 10 μm. In one aspect, the disclosed methods are useful for small particles, e.g. those having a median particle diameter of from about 0.1 to about 5 μm, including for example, particles having a median particle diameter of about 3 μm.

In one aspect, totally porous particles are present as a plurality of particles, wherein at least one of the totally porous particles is aggregated with smaller totally porous particle. With reference to the micrograph of FIG. 2, for example, it can be seen that at least one of the totally porous particles 210 comprising a porous silica core and a porous silica layer is aggregated with a smaller totally porous particle 215 that does not comprise the core. In one aspect, the plurality of particles is made by the disclosed methods.

The smaller particle that is aggregated with the multilayered porous particles result from particles that tend to form during coacervation which are comprised solely of particles from the particulate phase during the formation of the coacervation layer(s) around the core particle, and thus do not comprise the core particle. In one aspect, the plurality of particles is made by the disclosed methods.

At least two types of dimers/trimers/aggregates can form during the disclosed coacervation methods. First, dimers/trimers/aggregates comprising two or more totally porous particles can form. Typically, each particle in such dimers/trimers/aggregates are similar in size, thus allowing these dimers/trimers/aggregates to be removed by processes such as elutriation from the desired particles. Second, the inventive coacervation methods also produce another type of dimer/trimer/aggregate that comprises one or more totally porous particles aggregated with one or more smaller totally porous particle that does not comprise the core particle. This type of dimer/trimer/aggregate can often not be removed from the desired particles, due to their size similarities. Generally, the smaller totally porous particle of such a dimer/trimer/aggregate comprises a particle used in the particulate phase of the coacervate coating, without the core, which tends to form at about the same rate as the layer itself. It should be appreciated, however, this type of dimer/trimer/aggregate does not typically produce any substantial deleterious effects when using the particles in applications, for example chromatography.

The particles of the invention can be used in any desired application. In one aspect, the particles are used in a separation device. The separation device can, for example, comprise the plurality of particles discussed above. The separation device can also comprise a product of the disclosed methods. Examples of suitable separation devices include chromatographic columns, chips, solid phase extraction media, pipette tips and disks. A specific contemplated application is size exclusion chromatography. For size exclusion chromatography, the particles should have pores large enough to allow polymers with certain molecular weight to enter and leave the pores. For this application, there is a linear relation of retention time versus polymer molecular weight within certain range of pore sizes. The particles with certain pore sizes can only separate polymers with a corresponding molecular weight range. To separate polymer mixtures with a wide molecular weight range, the particles of the invention can be made such that an outer layer has a first pore size, to allow certain polymers to diffuse therethrough, while inner layers, or the core, can have a different, for example smaller or larger, pore size, such that polymers having a different molecular weight are diffused through those inner layers or the inner core. Generally, for this application, porous particles having pore sizes that decrease as the core is approached are useful. That is, the outer layer has a larger pore size than inner layer(s), if present, or the core. Likewise, multiple inner layers, when present, can have successively smaller pore sizes, such that layers closer to the core will have smaller pore sizes than layers farther away from the core.

### EXAMPLES

The following examples are put forth so as to provide those of ordinary skill in the art with a complete disclosure and description of how the compounds, compositions, and methods described and claimed herein are made and evaluated, and are intended to be purely exemplary and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in degrees Centigrade (° C.) or is at ambient temperature, and pressure is at or near atmospheric. There are numerous variations and combinations of reaction conditions, e.g., component concentrations, component mixtures, desired solvents, solvent mixtures, temperatures, pressures and other reaction ranges and conditions that can be used to optimize the product purity and yield obtained from the described process. Only reasonable and routine experimentation will be required to optimize such process conditions. In the following examples, particle size was measured using Beckman Coulter Counter instruments.

### Example 1

In the following examples, particle size was measured using Beckman Coulter Counter instruments. 111 g of 3.5 μm R×300 silica particles (pore size 300 Å, surface area 49 m²/g, Agilent Technologies) were bonded with 9.36 g of aminopropyltriethoxysilane (Gelest, catalog#SIA0610.0) in 400 ml of toluene under reflux condition overnight. After reaction, the silica particles were filtered, washed with toluene, THF and acetonitrile, and dried in a vacuum oven at 100° C. for 2 hours. A small sample was sent for carbon analysis (Microanalysis, Wilmington, Del.). The particles exhibited 0.53% carbon and 0.17% nitrogen.

### Example 2

31.18 g of 1.67 μm R×80 silica particles (pore size 80 Å, surface area 198 m²/g, Agilent Technologies) were bonded with 10.60 g of aminopropyltriethoxysilane (Gelest, catalog# SIA0610.0) in 120 ml of toluene under reflux condition overnight. The particles were worked up as in Example 1. The elemental analysis shows 2.44% carbon and 0.81% nitrogen.

### Example 3

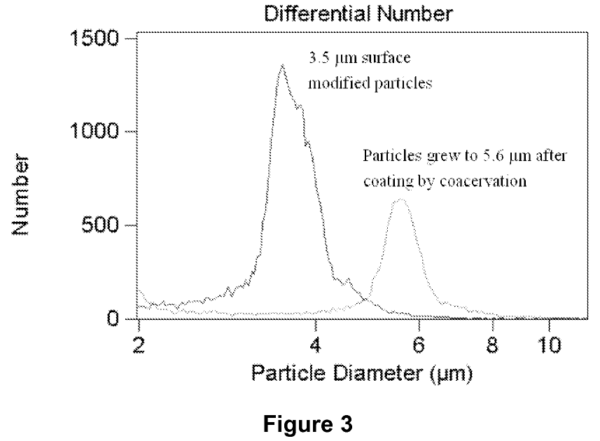

The coating of coacervate layer around the surface modified particle of Example 1 was prepared by gradual addition of urea and formaldehyde solution into the porous cores to gradually grow the particles to the desired thickness. 30 g of 3.5 μm surface modified particles made in Example 1, 540 g of 30 nm sol (flocculated from 2 nm sol, 5.87% SiO2), 24 g of nitric acid, and 900 g of water were slurried in a beaker. A solution of 31.8 g of urea (Aldrich, catalog# U5128) and 52.2 g of formaldehyde (Aldrich, catalog#252549) in 300 ml of water was added slowly. After addition, the mixture was allowed to settle overnight. The particles grew from 3.5 μm to 5.6 μm. FIG. 3 shows the Coulter Counter measurement comparison of the particle size before and after coacervation. The coated raw particles were heated at 600° C. for 10 hours to burn off the urea/formaldehyde polymer, and sintered at 1000° C. for 2 to 3 hours for strengthening. The surface of the sintered particles was then rehydroxylated by diluted hydrofluoric acid method described in J. Kohler and J. J. Kirkland, J. Chromatography., 385 (1987) 125-150, which is incorporated herein by this reference. After liquid elutriation fractionation to eliminate aggregated particles and fine particles, these particles demonstrated an average particle size of 5.1 μm as measured by Coulter Counter. The nitrogen absorption measurement by the Tristar instrument (Micromeritics, Norcross, Ga.) showed the average surface area of these particles of 108 m²/g and the average pore size of 210 Å.

### Example 4

10 g of 1.67 μm surface modified particles made in Example 2 were coated according to the procedure in Example 3. 10 g of 1.8 μm surface modified particles, 180 g of 30 nm sol (flocculated from 2 nm sol, 5.87% SiO₂), 8.4 g of nitric acid, and 300 g of water were slurried in a beaker. A solution of 10.6 g of urea and 17.4 g of formaldehyde in 100 ml of water was added slowly. After addition, the mixture was allowed to settle overnight. The particles grew from 1.67 μm to 3.24 μm. The silica particles were processed as in Example 3. The final particles demonstrated an average particle size of 2.69 μm as measured by Coulter Counter. The absorption measurement by the Tristar instrument shows the surface area of 184 m²/g and the average pore size of 136 Å, with two different pore size populations; one with peak around 80 Å and one with peak around 170 Å.

### Example 5

10 g of 1.67 μm surface modified particles made in Example 2 were coated according to the procedure in Example 4 except 146 g of 91 nm sol (7.22% SiO₂) were used instead of 30 nm sol. The particles grew from 1.67 μm to 4.28 μm. The silica particles were processed as usual. The final particles demonstrated an average particle size of 2.95 μm as measured by Coulter Counter. The absorption measurement by the Tristar instrument shows the surface area of 104 m²/g and the average pore size of 132 Å, with two different pore size populations; one with peak around 80 Å and one with peak above 500 Å. The resulting multilayered totally porous particles are depicted in the micrograph of FIG. 2.

### Example 6

The first coacervation step produces raw particles which have urea/formaldehyde polymer on the surface. These raw particles have the appropriate surface for applying the next coating by coacervation, such that the raw particles can be used directly as cores for the next coacervation without any further surface modification steps. If the sol used for second coacervation is different from the first coacervation, the pores formed in the second coacervation (outer layer) will be different from the first one (inner layer) after the polymer is burned off. The process can be repeated two or more times to form multilayers of different pore sizes and/or composition. Thus, 60 g of 3.0 μm raw particles made from coacervation using 14 nm sol were added into 1800 g of 91 nm sol (7.22% SiO₂, 130 g SiO₂) in a beaker, and were sonicated for 10 to 15 minutes to make sure the cores to break apart to single particles (checked by microscope and Coulter). The mixtures of the cores and the sol solution were poured into a big container, followed by addition of 3600 g of water and 70 g of urea. The mixture was stirred until urea was dissolved. 92 g of 70% nitric acid was poured into the mixture under rapid stirring. After 30 seconds, 123 g of formaldehyde were poured into the mixture. The mixture was kept under rapid stirring for 30 seconds, and then was allowed to sit still overnight. The particles grew from 3.0 μm to 5.8 μm raw particles. The raw particles were process as in Example 3. The final particles demonstrated an average particle size of 4.6 μm as measured by Coulter Counter. The absorption measurement by the Tristar instrument shows the surface area of 105 m²/g and the average pore size of 150 Å, with two different pore size populations; one with peak around 80 Å and one with peak above 500 Å.

What is claimed is:

1. A method for making totally porous particles, comprising:
providing a core particle;
forming a first coating on a surface of the core particle, wherein the first coating comprises a first continuous polymeric phase bonded to the core particle and a first particulate phase dispersed within the first continuous polymeric phase;
removing the first continuous polymeric phase from the first coating to provide a totally porous particle.

2. The method of claim 1, wherein the core particle comprises a porous metal oxide core particle having an organic surface modifier attached thereto.

3. The method of claim 2, wherein providing the surface modified porous metal oxide core particle comprises attaching the organic surface modifier to the porous metal oxide core particle.

4. The method of claim 1, wherein the core particle comprises a raw particle comprising a core particulate phase dispersed within a core continuous polymeric phase capable of being removed concurrently with removal of the first continuous polymeric phase of the first coating.

5. The method of claim 4, wherein providing the raw particle comprises contacting a metal oxide sol composition with one or more polymerizable residues.

6. The method of claim 1, further comprising:
prior to removing the first continuous polymeric phase, forming at least one subsequent coating layer, wherein the at least one subsequent coating layer comprises a subsequent continuous polymeric phase bonded to a previous continuous polymeric phase of a previous coating layer and a subsequent particulate phase dispersed within the subsequent continuous polymeric phase; and
wherein removing the first continuous polymeric phase from the first coating also removes the continuous polymeric phase of each subsequent coating layer to provide the totally porous particle.

7. The method of claim 6, wherein forming the at least one subsequent coating layer comprises contacting a previously formed coating layer with a composition comprising one or more polymerizable residues and a plurality of nano-sized metal oxide particles.

8. The method of claim 1, wherein forming the first coating layer on the surface of the core particle comprises contacting the core particle with a composition comprising one or more polymerizable residues and a plurality of nano-sized metal oxide particles.

9. The method of claim 1, wherein the core particle comprises one or more of silica, alumina, titania, zirconia, ferric oxide, antimony oxide, zinc oxide, or tin oxide.

10. A plurality of totally porous metal oxide particles comprised of a porous metal oxide core having a core pore size and one or more porous metal oxide layers surrounding the metal oxide core that each have a pore size that is the same or different than the core pore size; wherein at least one of the totally porous metal oxide particles is aggregated with a smaller totally porous particle having a substantially homogenous pore size.

11. The particles of claim 10, wherein the totally porous metal oxide particles comprise substantially porous cores having a size ranging from about 10% to about 99% of the total particle size;
wherein the one or more porous metal oxide layers have ordered pores and independent median pore size ranges from about 15 to about 1000 Å with a pore size distribution (one standard deviation) of no more than 50% of the median pore size;
wherein the totally porous metal oxide particles have a specific surface area of from about 5 to about 1000 m²/g; and
wherein the particles have a median size range from about 0.5 μm to about 100 μm with a particle size distribution (one standard deviation) of no more than 15% of the median particle size.

12. The particles of claim 10, wherein the totally porous particles have a diameter from about 0.5 μm to about 10 μm.

13. The particles of claim 10, wherein the totally porous particles comprise one or more of silica, alumina, titania, zirconia, ferric oxide, antimony oxide, zinc oxide, or tin oxide.

14. A totally porous particle comprising a porous metal oxide core and one or more porous metal oxide layers surrounding the metal oxide core; wherein at least one of the porous metal oxide layers surrounding the metal oxide core has a different pore structure than another layer.

15. The particle of claim 14, wherein the totally porous particle comprises a substantially porous core having a size ranging from about 10% to about 99% of the total particle size;
wherein the one or more porous metal oxide layers have ordered pores and independent median pore size ranges from about 15 to about 1000 Å with a pore size distribution (one standard deviation) of no more than 50% of the median pore size;
wherein the totally porous metal oxide particles have a specific surface area of from about 5 to about 1000 m²/g; and
wherein the particles have a median size range from about 0.5 μm to about 100 μm with a particle size distribution (one standard deviation) of no more than 15% of the median particle size.

16. The particle of claim 14, wherein the totally porous particle has a diameter from about 0.5 μm to about 10 μm.

17. The particle of claim 14, wherein the totally porous particle comprises one or more of silica, alumina, titania, zirconia, ferric oxide, antimony oxide, zinc oxide, or tin oxide.

18. A separation device having a stationary phase comprising a plurality of totally porous metal oxide particles comprised of a porous metal oxide core having a core pore size and one or more porous metal oxide layers surrounding the metal oxide core that each have a pore size that is the same or different than the core pore size;
wherein at least one of the totally porous metal oxide particles is aggregated with a smaller totally porous particle having a substantially homogenous pore size.

19. The separation device of claim 18, wherein the totally porous particles comprise substantially porous cores having a size ranging from about 10% to about 99% of the total particle size;
wherein the one or more porous metal oxide layers have ordered pores and independent median pore size ranges from about 15 to about 1000 Å with a pore size distribution (one standard deviation) of no more than 50% of the median pore size;
wherein the totally porous metal oxide particles have a specific surface area of from about 5 to about 1000 m²/g; and
wherein the particles have a median size range from about 0.5 μm to about 100 μm with a particle size distribution (one standard deviation) of no more than 15% of the median particle size.

20. The separation device of claim 18, wherein the totally porous particles comprise one or more of silica, alumina, titania, zirconia, ferric oxide, antimony oxide, zinc oxide, or tin oxide.
